(19) United States
(12) Patent Application Publication
(10) Pub. No.: US 2014/0015749 A1
(43) Pub. Date: Jan. 16, 2014

(54) CLOSED-LOOP CROWD CONTROL OF EXISTING INTERFACE

(71) Applicants: Jeffrey Philip BIGHAM, Rochester, NY (US); Walter Stephen LASECKI, Woodbridge, VA (US); Kyle Ian MURRAY, West Lafayette, IN (US); Samuel Christopher WHITE, Cupertino, CA (US)

(72) Inventors: Jeffrey Philip BIGHAM, Rochester, NY (US); Walter Stephen LASECKI, Woodbridge, VA (US); Kyle Ian MURRAY, West Lafayette, IN (US); Samuel Christopher WHITE, Cupertino, CA (US)

(73) Assignee: University of Rochester, Office of Technology Transfer, Rochester, NY (US)

(21) Appl. No.: 13/545,280

(22) Filed: Jul. 10, 2012

(51) Int. Cl. G09G 5/00; G06F 3/02; G09G 5/08

(52) U.S. Cl. 345/163; 345/156; 345/168

(57) ABSTRACT

“A computer-implemented method and system (“Legion”) for capturing and outsourcing an existing graphical user interface (“GUI”) of an application to a crowd for their collaborative real-time control using an input device are provided. A crowd refers to a dynamic pool of one or a plurality of anonymous worker of varying skill level and/or reliability. The pool is dynamic because workers are able to come and go at their leisure and no specific worker can be relied upon to be available at a given time or to continue working on a job for a specific amount of time. Mediation strategies for integrating the input of multiple crowd workers in real-time is also provided.”

### BACKGROUND OF THE INVENTION

1. Field of the Invention

The present invention relates to a computer implemented method and system for a group of users to collectively control an interface. More particularly, the present invention relates to a method and system for controlling an interface by combining inputs from a plurality of users in the group of users.

2. Description of the Related Art

Crowdsourcing has been shown to be an effective approach for solving difficult problems that are beyond the capabilities of current automated approaches. However, current crowdsourcing systems suffer two main limitations. Firstly, tasks must be repackaged for proper display to crowd workers, which generally requires substantial one-off programming effort and support infrastructure. Secondly, crowd workers generally participate asynchronously, without a tight feedback loop between their tasks.

### SUMMARY OF THE INVENTION

A computer-implemented method and system (“Legion”) for capturing and outsourcing an existing graphical user interface to one or more anonymous and dynamic workers of varying skill level and/or reliability, referred to herein as crowd workers or crowd, for their collaborative real-time control using an input device are provided. The present invention provides a new approach to crowd computing by using existing graphical user interfaces and putting crowd workers in control of the mouse and keyboard. Mediation strategies for integrating the input of multiple crowd workers in real-time is also provided.

According to an embodiment of the present invention, a computer-implemented method of capturing and outsourcing an existing graphical user interface to a crowd for their collaborative real-time control of the graphical user interface using an input device includes receiving input selecting a portion of an existing desktop interface to be controlled by a crowd, transmitting a video stream of the selected portion of the existing desktop interface, and simulating an input event based on at least one input event received from the crowd, wherein the crowd includes a plurality of workers.

According to an embodiment of the present invention, the method also includes receiving a natural language description of a task the crowd is to perform using the portion of the existing desktop interface.

According to an embodiment of the present invention, the method also includes receiving a natural language description of an amount that will be paid to at least one user in the plurality of users for performing the task the crowd is to perform using the portion of the existing desktop interface.

According to an embodiment of the present invention, the crowd performs the task using the portion of the existing desktop interface is the control of a robot.

According to an embodiment of the present invention, the crowd performs the task using the portion of the existing desktop interface is performing data processing using a word processor or spreadsheet.

According to an embodiment of the present invention, the crowd performs the task using the portion of the existing desktop interface is playing a game.

According to an embodiment of the present invention, synthesizing at least one input event includes receiving input from a single worker in the plurality of workers, receiving input from the plurality of workers, wherein the input from the plurality of workers are serialized.

According to an embodiment of the present invention, synthesizing at least one input event include, receiving input from the plurality of workers, wherein an input receiving the most votes during a time period is the simulated input.

According to an embodiment of the present invention, synthesizing at least one input event includes receiving input from a worker in the crowd chosen randomly from the plurality of workers until the randomly chosen worker becomes inactive.

According to an embodiment of the present invention, synthesizing at least one input event includes receiving input from a plurality of workers in the crowd wherein an input from a worker in the crowd elected as a leader is the simulated input.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a computer system for controlling an interface by combining inputs from a plurality of users in the group of users according to an embodiment of the invention.

FIG. 2 is an exemplary diagram of a graphical user interface split into a grid according to an embodiment of the present invention.

FIG. 3 is an exemplary interface web page according to an embodiment of the invention.

FIG. 4 is an exemplary flowchart for a method of controlling an interface by combining inputs from a plurality of users in the group of users according to an embodiment of the invention.

### DETAILED DESCRIPTION OF THE INVENTION

A computer-implemented method and system (“Legion”) for capturing and outsourcing an existing graphical user interface (“GUI”) of an application to a crowd for their collaborative real-time control using an input device are provided. As used herein, a crowd refers to a dynamic pool of one or a plurality of anonymous worker(s) of varying skill level and/or reliability. The pool is dynamic because workers may come and go at their leisure and no specific worker may be relied upon to be available, although they could be, at a given time or to continue working on a job for a specific amount of time. The pool is also dynamic because workers are not to be relied upon to provide high-quality work of the type one might expect from a traditional employee that would perform a task for various reasons that include, but are not limited to, misunderstanding of task directives, laziness, or even maliciousness.

The invention provides a new approach to crowd computing by using existing graphical user interfaces and putting crowd workers in control of the mouse and keyboard. Mediation strategies for integrating the input of multiple crowd workers in real-time is also provided. Mediation includes synthesizing input from a plurality of workers by identifying when workers in the crowd provide the same input at the same time. In an embodiment of the invention, inputs from a plurality of workers need to be provided discretely within a time period, also referred to as an input space, to be recognized.

The duration of an input space is application specific and based on the GUI to be controlled. For example, GUI applications vary from being controllable by a few discrete keys to using the full continuous input of a pointing device, such as a mouse clicks. Discrete input types include, but are not limited to, key presses, and mouse/pointer clicks, which are usually discrete in the space of the pixel locations. In an embodiment of the invention, the space responsive to pointer clicks is reduced to a fixed grid defined by a select portion of a graphical user interface for an application operating on an end user device. The reduction of the size of the space responsive to pointer clicks facilitates the aggregation of a plurality of pointer clicks.

Many tasks that can be implemented using a GUI have several different, but equally correct ways of completing them. For instance, if the task is to navigate a robot around an obstacle to a specified location, there are at least two reasonable high-level paths, which are going left around the obstacle or going right around the obstacle. Applications can be characterized by the number of options there are to choose from at different times during the execution of the applications. Crowd input can be expected to diverge more at such decision points. According to an embodiment of the invention, time is divided into discrete windows or epochs and inputs received in the same epoch are associated with one another in order to correlate worker inputs that are received over time. Tasks with more decision points may be more easily performed using mediation strategies that allow for longer terms strategies that are implemented over multiple epochs

Dimensions of the crowd relevant to enabling real-time graphical user interface control include the time each recruited worker continues working on the task and the quality of the worker's output. A related dimension is the latency required to recruit workers to perform a particular task. In an embodiment of the present invention, workers are made available quickly, recruited and kept available using systems including, but not limited to, quikTurkit™.

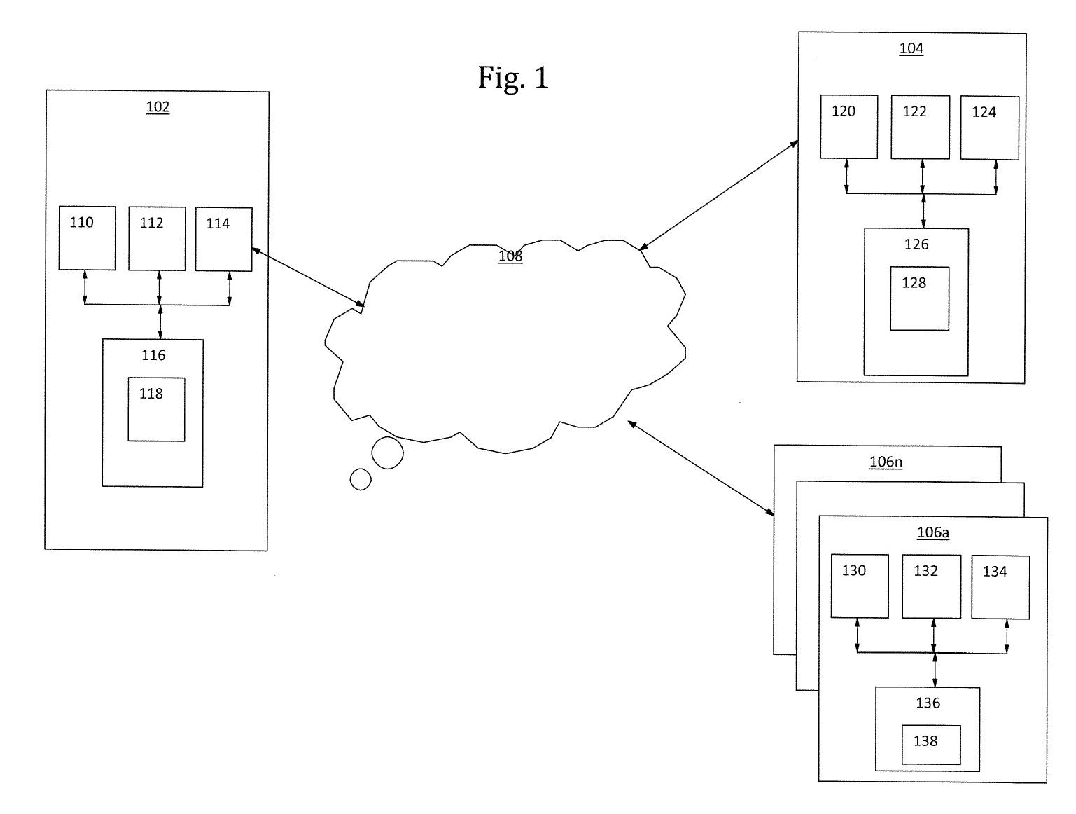

As an example, such features may be provided in a network system 100 such as that shown in FIG. 1. Network system 100 includes an end user device 102, server device 104, one or a plurality of crowd worker devices 106a-106n, and a network 108. Network 108 includes any communications network that is now in service or which may be developed in the future. Such a network may include one or more public or private communications networks, such as the Internet, wired or wireless telephone networks, wired or wireless data networks, local area networks, etc.

In an embodiment of the invention, end user device 102 includes an end user client application for capturing and controlling interfaces for use by the crowd in performing tasks. End user device 102 can be any type of device that executes applications utilizing graphical user interfaces for performing tasks. System 102 includes one or more processors (CPUs) 110a-110n, input/output circuitry 112, network adapter 114, and memory 116. One having ordinary skill in the art will understand that there are a number of different components that can be included in an end user device without departing from the spirit and scope of the present invention.

CPUs 110a-110n execute program instructions in order to carry out the functions of the end user client application. System 102 can be implemented as a single multi-processor computer system or as a plurality of networked computer systems, which may be single-processor computer systems, multi-processor computer systems, or a mix thereof Input/output circuitry 112 provides the capability to input data to, or output data from, system 102. Network adapter 114 interfaces device 102 with network 108.

Memory 116 stores program instructions that are executed by, and data that are used and processed by, CPU 110 to perform the functions of system 102 including the end user client 118. In an embodiment of the invention, the end user client 118 allows end users—the party or entity outsourcing a task—to select a portion of their screen—the defined region—to be controlled by the crowd by drawing a box around the portion of the screen to be controlled. Allowing the user to choose the region of the screen to be controlled and exported to the crowd, instead of choosing a particular window, offers flexibility since it allows users to exercise control over the information shared with the crowd, exposes simpler interfaces for workers comprising only necessary client interface components required for performing the task, and creates new mash-ups (e.g., new application that are created by combining pieces of another application) by sharing pieces of multiple applications arranged next to one another. The export of smaller regions of the screen to be controlled also lowers the bandwidth required for export.

In an embodiment of the invention, end users provide a natural language description of the task that they would like the crowd to complete, and create a legend of keys that the crowd can use and where they are able to click. In an embodiment of the invention, to simulate mouse clicks and keyboard events at the end user device 102, end user client 118 post events into the event stream at specific screen locations on the end user device 102. In an embodiment of the invention, the end user client 118 uses a library, such as the CamTwist™ library, to capture video from the end user device's 102 screen and transmits the captured video to the server device 104. Keys and mouse clicks in the defined region are simulated by the end user client 118. This does not completely ensure security, but reduces what workers are able to control on the client interface.

Server device 104 can be any type of device that runs one or more applications to serve the requests of other programs, such as the end user client 118, or users on the network 108. Server device 104 may include personal computers and the like. Server device 104 includes one or more processors (CPUs) 120a-120n, input/output circuitry 122, network adapter 124, and memory 126. CPUs 120a-120n execute program instructions in order to carry out the functions of the server application 128. Sever device 104 can be implemented as a single multi-processor computer system or as a plurality of networked computer systems, which may be single-processor computer systems, multi-processor computer systems, or a mix thereof Input/output circuitry 122 provides the capability to input data to, or output data from, sever device 104. Network adapter 124 interfaces server device 104 with network 108.

Memory 126 stores program instructions that are executed by, and data that are used and processed by, CPU 120 to perform the functions of sever device 104 including server application 128. In an embodiment of the invention, server application 128 is a Java™ application that recruits multiple workers from the crowd, collects, mediates, and forwards worker key presses and mouse clicks to the end user client application, and pays workers for their work. In an embodiment of the invention, to recruit workers for the crowd, server application 128 uses a script platform, such as quikTurkit, which maintains an active pool of workers. HITs or tasks are described using the short task description provided by the end user via the end user client application. Workers can either be recruited on-demand or automatically when the user opens the application in anticipation of future need. In an embodiment of the invention, if workers arrive early they are paid to wait. In an embodiment of the present invention, a dynamic pool of at least 3-5 workers are maintained.

In an embodiment of the present invention, server application 128 also includes Flash Media Server (“FMS”) Video is streamed from the end user client to FMS, which supports multiple workers receiving the stream via their web browsers from the FMS. In an embodiment of the present invention, the video is compressed and sent using the User Datagram Protocol (UDP), which allows packets to be dropped. As a result, if bandwidth is temporarily reduced between server device 104 and the workers in the crowd, frames from the video will be dropped instead of being queued, which helps to ensure that the frame currently being shown is the most recent.

In an embodiment of the present invention, crowd worker devices 106a-106n can be any type of device operable to receive and display streaming video streams, collect and transmit input from a worker operating the respective crowd worker device 106, and provides the worker operating the respective crowd worker device 106 with feedback. Crowd worker devices 106a-106n can include personal computers and the like. A Crowd worker device can include one or more processors (CPUs) 130a-130n, input/output circuitry 132, network adapter 134, and memory 136. CPUs 130a-130n execute program instructions in order to carry out the functions of the worker interface application 138. A Crowd worker device 106 can be implemented as a single multi-processor computer system or as a plurality of networked computer systems, which may be single-processor computer systems, multi-processor computer systems, or a mix thereof Input/output circuitry 132 provides the capability to input data to, or output data from, sever device 104. Network adapter 134 interfaces A Crowd worker device 106 with network 108.

Feedback includes, but not limited to, reflecting a worker's last key press and whether the end user device's graphical user interface runs one or more applications to serve the requests of other programs, such as the end user client application, or users on the network 108. Worker key presses and mouse clicks are sent to the server 104, which aggregates them and uses one of several input mediators to choose which events to send to the end user client 118. The server 104 allows inputs to be analyzed, aggregated, and filtered in a number of ways. The server 104 includes a number of procedures for deciding which inputs to pass through, for blocking or allowing inputs only from certain workers, or for analyzing inputs over time windows. End users will neither write these procedures nor need to decide between them.

Workers, using a respective crowd worker device 106, control the graphical user interface of end user device 102 via a web page hosted by the server 104. FIG. 3 is an exemplary interface web page hosted by server 104 according to an embodiment of the invention. Web page 300 displays the live video feed of the graphical user interface of end user device 102 and feedback to the worker operating the respective crowd worker device 106. In an embodiment of the invention, as recruited workers are queued into the pool of workers, each worker in the plurality of workers can play a simple game in which they are shown a letter and asked to type what it displayed. In an embodiment of the invention, the game can be a test to identify recruited workers who provide bad input, and thus are unreliable, or whose latency is too high. In an embodiment of the invention, workers are shown their current crowd agreement score, which can be represented by formula (1) shown herein below, in a power meter, which can be used as a multiplier against a maximum bonus workers can receive for performing the task for which they were recruited on web page 300. A crowd agreement score measures how closely a worker's input has agreed (been the same as) other crowd workers over a period of time. Parameters influencing the calculation of this score include the time period over which agreement is calculated, metrics for ‘agreement’ (considering exact agreement only may either not be desirable or may not be possible, or easy, to compute), and which subset of other workers will be considered when calculating agreement (all workers, just those meeting specific qualifications, e.g. quality, similarity).

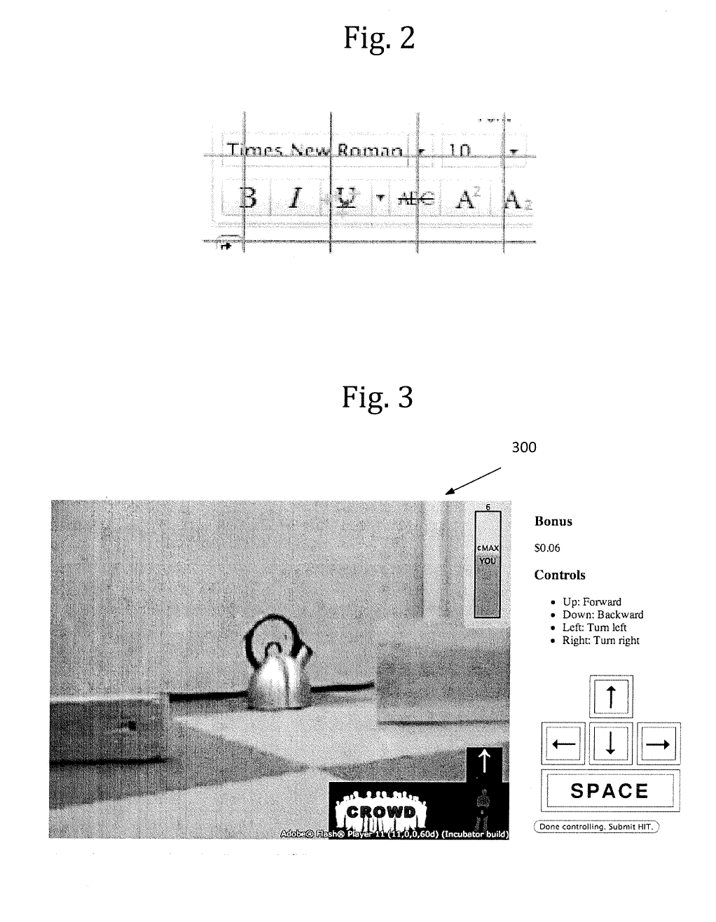

An exemplary portion of a controlled graphical user interface according to an embodiment of the invention is shown in FIG. 2. The input mediation strategies implemented according to embodiments of the present invention require inputs to be discrete. This is straightforward for key presses. In the embodiment of FIG. 2, a portion of a graphical user interface for an application used for performing a task is split into a grid for discretizing user inputs, such as mouse clicks, and the grid cell in which a mouse click occurs is used as the discrete input.

In an embodiment of the present invention, a descriptor for referencing a mouse click in a grid is generated. For example, a descriptor mc_{—}12_{—}20 would reference a mouse click in the grid cell at position (12,20). In an embodiment of the invention, mouse clicks can be clustered to find a discrete set of possible inputs to select from for simulation. Discrete inputs allow the input mediators to compare the inputs of crowd workers. Inputs that are semantically the same will be discretized into different cells of the grid. In an embodiment of the present invention, to simulate user worker input, the end user client application either uses the coordinates of a mouse click in a grid cell or averages of all positions for x's and y's of each of a plurality of mouse clicks. The technique implemented by the end user client application is dependent on the mediation strategy being applied by server 104 to perform the outsourced task.

Mediation of inputs from workers in the crowd is performed by system 100 in a number of ways. Each of the he input mediation techniques balance reliability and latency differently. According to an embodiment of the invention, system 100 aggregates the input from all of the workers in the crowd into a single input that is forwarded to the graphical user interface of end user device 102 as if it was sent by a single user. In an embodiment of the invention, system 100 implements the solo input mediation technique, which recruits a single worker to directly control the graphical user interface of end user device 102. Latency will be low but so will reliability. In an embodiment of the invention, system 100 implements the mob input mediation technique, which simply serializes the inputs from each of the workers and sends the single stream of actions to the graphical user interface of end user device 102. Each input from a worker is immediately sent to the graphical user interface being controlled.

In an embodiment of the present invention, system 100 implements the Vote mediation technique, which attempts to address the problem of unreliable individual crowd workers. The Vote mediation technique uses a weighted vote, in which each user has a corresponding weight that acts as an influence measure. At the end of each epoch, individual worker's most recent inputs are collected as votes and scaled based on the weight of the worker who cast the vote, then summed to find the input with the highest weighted value amongst all participating workers. In an embodiment of the invention, this input is then sent to the client and the weights of each worker wᵢ are recomputed according to the following formula:

$${w}_{i}^{( l + 1 )} = α {w}_{i}^{( l )} + ( 1 - α ) \frac{{\sum }_{j = 1}^{{N}_{{A}_{i}}} {w}_{j}^{( l )}}{N} \qquad ( 2 )$$

Where t is the current epoch, N Ai is the number of workers that voted for selected action Ai and N is the total number of workers casting votes. α is a discount factor selected such that α<1. Its effect is that a worker's influence is affected more by recent agreement with the crowd than historical agreement. Using worker inputs as votes can improve accuracy, but at the cost of slowing down response time. In an embodiment of the invention, an epoch of 1-2 seconds is used. In an embodiment of the invention, an epoch of 2-4 seconds is used. In an embodiment of the invention, an epoch of 4-8 seconds is used.

In an embodiment of the present invention, system 100 implements the Leader mediation technique, which attempts to address the problem of unreliable individual crowd workers. To reduce the latency inherent in gathering votes over the span of an epoch, the Leader mediation technique selects the highest influence worker as the leader, at the beginning of each epoch, to assume direct control of the graphical user interface for the duration of the epoch. Each input entered by the leader is immediately forwarded to the graphical user interface being controlled. Since the leader is elected based on weight, they serve as leader for as long as they remain in agreement with the crowd, on average.

The leader mediation technique provides for real-time responses to feedback from the system without sacrificing the benefits of crowd agreement and enables longer term plans. For example, suppose a navigation task requires a decision to be made as to which path to take in order to avoid an obstacle. In the vote or mob mediation techniques, close crowd decisions can result in actions belonging to disparate plans being performed in a sequence because of crowd weight and participation fluctuations. This may lead to a course of action which is not in alignment with any individual worker's plan. In the navigation example, this may result in colliding with the obstacle. Electing a single leader allows them to take consecutive actions coinciding with their individual plan.

Worker weights are calculated using a bag-of-votes model to choose a leader after each epoch. In an embodiment of the invention, these weights are calculated by comparing the normalized actions of each worker to the actions of the crowd with the vector-cosine derived from the following formula:

$$VC ( {a}_{i} , c ) = \frac{{a}_{i} \cdot c}{‖ {a}_{i} ‖ * ‖ c ‖} \qquad ( 2 )$$

where aᵢ is a vector of the proportion of votes cast for each action by the ith worker and c is the same dimension vector computed for the whole crowd. In an embodiment of the invention, the worker's weight is recomputed after each epoch, but the vector-cosine is used as the new crowd agreement metric, which is derive from the following formula:

ωᵢ^{(t+1)}=αωᵢ^{(t)}+(1−α)VC(αᵢ^{(t)}, c) (3)

where α<1 is the same discount factor as in Eq. I.

In an embodiment of the present invention, system 100 implements the Active mediation technique. The Active mediation technique is variation on the leader mediation technique that tease apart the two benefits of the leader mediation technique, which include control by a single worker in the crowd and the selection of a worker that has been shown to agree the most with the crowd. The active input mediator randomly selects a worker, who maintains control as long as they continue to provide input. If they fail to provide input during some number of consecutive epochs a new random worker is selected.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable storage media include, floppy disks, hard disk drives, CD-ROMs, DVDROMs, RAM, flash memory, etc.

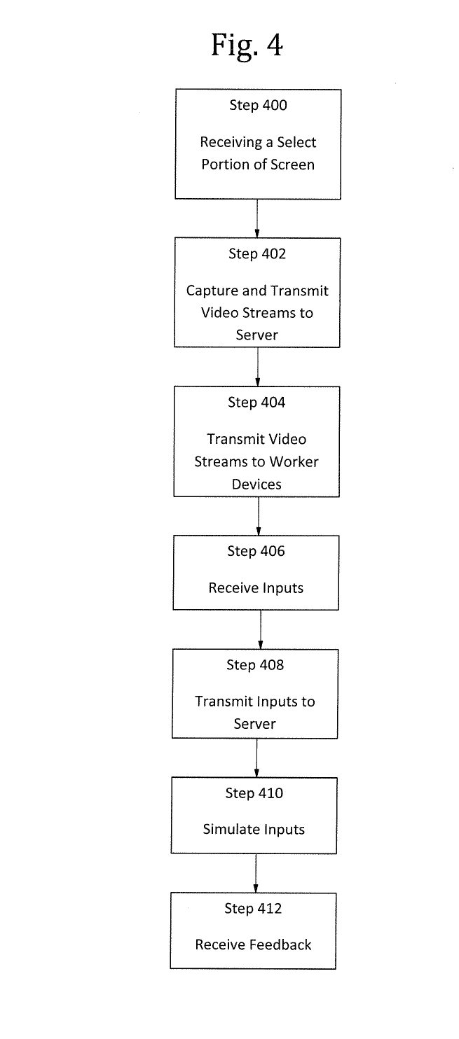

FIG. 4 is an exemplary flowchart for a method of controlling an interface by combining inputs from a plurality of users in the group of users according to an embodiment of the invention. In step 400, receiving a select portion of an interface to be controlled by the crowd (e.g., plurality of users in the group of users) by drawing a box around the portion of the screen to be controlled. In an embodiment of the invention, end users that are outsourcing the control of an interface provide a natural language description of the task that they would like the crowd to complete, create a legend of keys that the crowd can use and where they are able to click.

In step 402, video streams of the selected portion of the end user's screen are capture by end user client 118 and transmitted from the end user device to the server device 104.

In step 404, video streams of the selected portion of the end user's screen are transmitted from the server device 104 to the crowd worker devices 106 of workers in the crowd. In step 406, one or more crowd workers devices receive inputs including, but not limited to, key presses and mouse clicks from crowd workers. In step 408, one or more crowd worker devices transmit inputs received from their respective worker operating the respective crowd worker device 106 to server 104, which aggregates them and uses one of several input mediators to choose which events to send to the end user client 118.

In step 410, to simulate user input, such as, but not limited to, mouse clicks and keyboard events, at the end user device 102, end user client 118 post events into the event stream at specific screen locations on the end user device 102. Inputs in the defined region are simulated by the end user client 118. This does not completely ensure security, but reduces what workers are able to control on the client interface.

In step 412, the crowd worker device 106 receives feedback.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims. There may be many other ways to implement the invention. Various functions and elements described herein may be implemented differently from those shown without departing from the spirit and scope of the invention. Various modifications to these embodiments will be readily apparent to those skilled in the art, and generic principles defined herein may be applied to other embodiments. Thus, many changes and modifications may be made to the invention, by one having ordinary skill in the art, without departing from the spirit and scope of the invention.

What is claimed is:

1. A computer-implemented method of controlling a user interface by combining inputs from a plurality of users in the group of users, the method comprising:
transmitting video streams of a select portion of a user interface to have controlled by the plurality of users in the group of users;
receiving inputs, wherein each input is an aggregate of inputs generated by a plurality of crowd worker devices operated by the plurality of users in the group of users; and
simulating the inputs at specific locations on the select portion of the user interface.

2. The method of claim 1, further comprising receiving input specifying a select portion of the user interface to have controlled by the plurality of users in the group of users.

3. The method of claim 2, further comprising capturing video streams of the select portion of the user interface to have controlled by the plurality of users in the group of users.

4. The method of claim 1, wherein the simulated inputs includes mouse clicks.

5. The method of claim 1, wherein the simulated inputs includes key presses.

6. The method of claim 1, further comprising transmitting a description of a task for which the user interface is being used.

7. The method of claim 1, further comprising transmitting a legend of the inputs that can be provided.

8. A computer-implemented method of controlling a user interface by combining inputs from a plurality of users in the group of users, the method comprising:
transmitting video streams of a select portion of a user interface to have controlled by the plurality of users in the group of users;
receiving inputs generated by a plurality of crowd worker devices operated by the plurality of users in the group of users;
aggregating the inputs generated by a plurality of crowd worker devices into an input; and
transmitting the input for simulation at specific locations on the select portion of the user interface.

9. The method of claim 7, further comprising receiving the video streams of the select portion of the user interface to have controlled by the plurality of users in the group of users.

10. The method of claim 7, wherein the simulated input includes a mouse click.

11. The method of claim 7, wherein the simulated input includes a key press.

12. The method of claim 7, further comprising transmitting a description of a task for which the user interface is being used.

13. The method of claim 7, further comprising receiving a description of a task for which the user interface is being used.

14. A computer program product for controlling a user interface by combining inputs from a plurality of users in the group of users, comprising:
a computer readable storage medium;
computer program instructions, recorded on the computer readable storage medium, executable by a processor, for performing the steps of:
transmitting video streams of a select portion of a user interface to have controlled by the plurality of users in the group of users;
receiving inputs, wherein each input is an aggregate of inputs generated by a plurality of crowd worker devices operated by the plurality of users in the group of users; and
simulating the inputs at specific locations on the select portion of the user interface.

15. The computer program product of claim 14, further comprising computer program instructions, recorded on the computer readable storage medium, executable by a processor, for performing the step of receiving input specifying a select portion of the user interface to have controlled by the plurality of users in the group of users.

16. The computer program product of claim 15, further comprising computer program instructions, recorded on the computer readable storage medium, executable by a processor, for performing the step of capturing video streams of the select portion of the user interface to have controlled by the plurality of users in the group of users.

17. The computer program product of claim 14, further comprising computer program instructions, recorded on the computer readable storage medium, executable by a processor, for performing the step of transmitting a description of a task for which the user interface is being used.

18. The computer program product of claim 14, further comprising computer program instructions, recorded on the computer readable storage medium, executable by a processor, for performing the step of transmitting a legend of the inputs that can be provided.

19. A computer program product for controlling a user interface by combining inputs from a plurality of users in the group of users, comprising:
a computer readable storage medium;
computer program instructions, recorded on the computer readable storage medium, executable by a processor, for performing the steps of:
transmitting video streams of a select portion of a user interface to have controlled by the plurality of users in the group of users;
receiving inputs generated by a plurality of crowd worker devices operated by the plurality of users in the group of users;
aggregating the inputs generated by a plurality of crowd worker devices into an input; and
transmitting the input for simulation at specific locations on the select portion of the user interface.

20. The computer program product of claim 19, further comprising computer program instructions, recorded on the computer readable storage medium, executable by a processor, for performing the step of receiving the video streams of the select portion of the user interface to have controlled by the plurality of users in the group of users.
